(19) United States
(12) Patent Application Publication
(10) Pub. No.: US 2021/0362643 A1
(43) Pub. Date: Nov. 25, 2021

(54) Anti-Loosing Strapping Device

(71) Applicants: Zili Wang, Contra Costa, CA (US); Jianfeng Liu, San Francisco, CA (US)

(72) Inventors: Zili Wang, Contra Costa, CA (US); Jianfeng Liu, San Francisco, CA (US)

(21) Appl. No.: 16/562,425

(22) Filed: Sep. 5, 2019

(51) Int. Cl. B60P 7/08

(52) U.S. Cl. CPC B60P 7/0846

(57) ABSTRACT

The utility invention provides a one-way locking method using an anti-loosing strapping device for securing cargo and goods for storage and transport. It rotates a clutch cam with an operating handle and the clutch cam. The utility invention utilizes an anti-loosing strapping device, when used, the operating handle allows the free rotation of the ratchet allows the buckle to be pulled away from the ratchet to clutch cam, and the strap can be pulled out under the effect of an external force. Once the force is loosened the strap will tighten up automatically and rotate into the position where the buckle is locked by the ratchet to clutch cam. The locking method of this kind of ratchet is one-way locking, the strap can only tighten up and cannot be pulled out. Through the improvement to the structure, the combination of the strap and the ratchet mechanisms with ability to separate simultaneously, improves reliability and stability of the anti-loosing strapping device. Therefore, the invention provides better control, convenience, reliability and stability as an anti-loosing strapping device.

### BACKGROUND

The present invention relates to a strap locking device for fixing in place and bundling of cargo or goods for storage and transportation.

The current existing strapping devices for transit poses several problematic issues and limitations. The force used may result in the deformation of loose items. Furthermore, as the current strapping devices do not maintain proper tension, it requires constant re-tightening during use. For example, the most common strap locking means used is where the strap is wound around a rotating shaft, one end of the rotation shaft fixed to the bracket, the rotation shaft of the traction device, the rotation axis of the string connected with the ratchet, and the spring clutch, wherein between the ratchet and the rotary shaft is fixedly connected to a rotating shaft rotatable clutch, the clutch spring against the ratchet wheel, the torsion spring is provided between the holder has a pawl and bracket with the clutch detent bumps and grooves. Due to structural reasons, such a strap locking means during transit will become loose and requires repeated tightening due to frictional forces on the device. This makes the use of the device inconvenient or impractical. Furthermore, while the strap is wound between the ratchet shafts, the ratchet pawl control member and the strap and other operations within the same housing is prone to failure due to winding.

### SUMMARY

The objective of the present invention resolves the above-described technical problems in present strapping devices and to provide a convenient handling, customizable means to secure cargo and goods for storage and transportation.

### DESCRIPTION OF THE DRAWINGS

FIG. 1 is a schematic structural diagram of the strap locking device according the present invention.

FIG. 2 is a schematic view of a part of the control configuration of the ratchet.

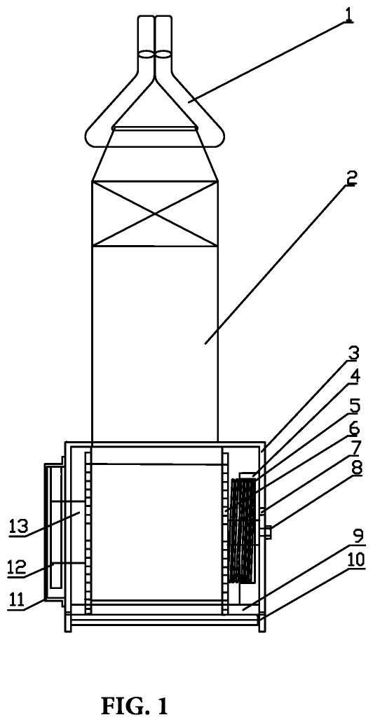

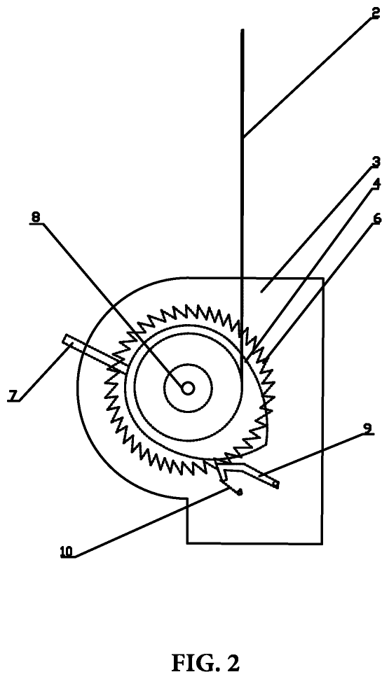

FIGS. 1 and 2 show an anti-hold loose strap device, which comprises a bracket (3), one end of the strap (2) are hook to the hole or ring (1), the other end of the catch strap is wound around a rotator shaft (12), the rotating shaft is fixed to the holder frame (3), one end of the rotation shaft (12) is on the side of the frame (3) the rotation shaft (12) extends into an outer end torsion spring cap (10), the torsion spring cap (10) between the rotary shaft (12) is connected to tighten the wrap spring (11), wherein the other end of the rotating shaft (12) on the frame (3) is attached to the outer holder (4) which has an outer rotary shaft (12) projecting on the frame (3), the rotation shaft (12) connected in series to the ratchet (5), the clutch cam (6) and the spring (7), wherein between the ratchet (5) is connected in a fixed position to the rotary shaft (12), the clutch cam (6) is rotatable on a rotation axis (12), the spring (7) and the ratchet (5) of the clutch cam (6) by the spring (7) against the frame (3) and outer holder (4), the clutch operating cam (6) has a handle (13), the locking panel (8) is provided on the outer holder (4), there torsion spring (9) allows the rotation into the pinch position to one-way lock the ratchet wheel (5), with the clutch operating cam (6) rotating the handle (13), in the clutch cam (6), the range of activities, the clutch cam (6) allows the locking panel pinch (8) to lock against the force of the torsion spring (9), which achieves a 8-way pinch ratchet (5) and the locking panel (8) locking the ratchet (5).

### DETAILED DESCRIPTION

The technical solution of the present invention is: A strap locking means, which includes a bracket and a strap, one end of the other end of the catch strap, the strap is wound around a rotating shaft, the rotating shaft is fixed on the holder, one end of the rotary shaft protruding on the side bracket, the bracket is extended beyond the rotation axis of the torsion spring at the end cap, the end cap is connected in a torsion spring and the tightening of the torsion spring between the rotary shaft, wherein said rotation the other end of the shaft projecting on the other side of the bracket, the rotation shaft extending beyond the bracket into the outer bracket, connected in series with a ratchet wheel rotating shaft, the clutch cam and a spring, wherein there is a fixed connection between the ratchet and the rotary shaft, the clutch cam can rotate around the rotary shaft between the ratchet and the spring. The clutch is pressed against the action of the spring, an operation handle provided on the outer holder pinch, the pinch can rotate the clutch cam, and the outer torsion locking bracket acts against the force of the torsion spring locking pinch when rotated to the locking positions with a one-way ratchet clutch cam rotation operation handle, the lock overcomes the torsion force, to achieve the pinch-way ratchet locking and release of ratchet.

The invention strap locking means, is used by rotating the operation handle, the clutch cam is rotated to a position to pinch off the ratchet, the strap can be freely pulled out under the action of external force and when let go, it automatically tightens and then the clutch cam is rotated to the position of the pinch-way locking ratchet. This locking ratchet locking is unidirectional, only tighten the strap and will not loosen. At the same time, the ratchet wheel, the torsion spring, the locking trigger, and a control section is utilized to achieve a ratchet strap separation. Accordingly, the present invention is an adaptable, stable and reliable locking strap means.

1. A cargo strap locking device, comprising:
(a) a bracket (3) and the strap (2), one end of the strap (2) has a buckle (1), the other end of the strap (2) is wound around an axis of rotation (12), the rotating shaft (12) is fixed on the bracket (3), one end of the rotary shaft (12) is attached on the side of the bracket (3) next to the torsion spring cap (10), a torsion spring (11) in the cap (10) and between the rotary shaft (12) is connected to the tightened torsion spring (11), wherein the other end of the rotating shaft (12) extends to the bracket (3) on the other side which is connected to an outer bracket (4), the rotation shaft (12) is connected in series with a ratchet wheel (5), the clutch cam (6) and a spring (7), wherein the ratchet wheel (5) and the rotating shaft (12) is fixedly connected to the clutch cam (6) and rotatable on the rotation shaft (12),
(b) a spring (7) by the ratchet wheel (5) and a clutch cam (6), holds against the action of the spring (7) of the outer bracket (4), an operating handle (13) on the clutch cam (6), an outer bracket (4) provided on the pinch (8),
(c) pinch (8) can be rotated on the outer torsion locking bracket (4) to locking the torsion spring (9) and the rotational force to the pinch ratchet (5), the rotation of the clutch cam (6) with the operating handle (13), in the clutch cam (6) of the movable range, the clutch cam (6) uses the locking pinch (8) against the force of the torsion spring lock (9), to achieve the one-way locking to release the ratchet wheel (5);
wherein said device locks and secures goods and cargo without slip or loosening.
